(19) United States
(12) Patent Application Publication
(10) Pub. No.: US 2012/0318112 A1
(43) Pub. Date: Dec. 20, 2012

(54) COVERING DEVICE FOR CUTTING MACHINE AND CUTTING MACHINE HAVING THE SAME

(75) Inventor: Hideharu MUTO, Anjo-shi (JP)

(73) Assignee: MAKITA CORPORATION, Anjo-shi (JP)

(21) Appl. No.: 13/486,709

(22) Filed: Jun. 1, 2012

(30) Foreign Application Priority Data
Jun. 16, 2011 (JP) 2011-134388

(51) Int. Cl. B26D 7/26; B26D 1/16

(52) U.S. Cl. 83/478; 83/508.2

(57) ABSTRACT

A covering device for a cutting machine includes a fixing cover provided on a base and covering a disc-shaped rotary tool provided at an end of the cutting machine. The fixing cover includes a tiltable body coupled to the fixing cover such that the tiltable body can be tilted in an up-down direction. The amount by which the rotary tool projects downward from the base can be changed by changes of the tilt position of the tiltable body with respect to the fixing cover. The fixing cover further includes a variable member having a plurality of abutment portions that are brought into abutment with the tiltable body along with a downward tilt of the tiltable body, and allows the tilt position to be selected from different tilt positions in accordance with an operation to select from the plurality of abutment portions.

### BACKGROUND OF THE INVENTION

This application claims the benefit of Japanese Patent Application No. 2011-134388 filed on Jun. 16, 2011, the entirety of which is incorporated by reference.

### FIELD OF THE INVENTION

The present invention relates to a covering device for a cutting machine and a cutting machine having the same, the covering device configured to change the amount by which a rotary tool of a cutting machine projects downward from a base by changes of the tilt position of a tiltable body having the rotary tool with respect to a fixing cover disposed on the base and covering the rotary tool.

### DESCRIPTION OF THE RELATED ART

Japanese Patent Application Publication No. 2007-111853 (JP 2007-111853 A), for example, describes a covering device for a cutting machine to cover a disc-shaped rotary tool driven by the cutting machine. The covering device is capable of adjusting the depth to which the rotary tool cuts into a workpiece. In the covering device for a cutting machine according to JP 2007-111853 A, the rotary tool is rotatably held by a tiltable body having a depth stopper that can move along the outer circumferential surface of the tiltable body. Further, the depth stopper is coupled to a cover main body by a coupling unit, and the cover main body is fixed to the covering device for the cutting machine.

In the conventional covering device for the cutting machine, the depth stopper is moved along the outer circumferential surface to be fixed at a desired position of the tiltable body corresponding to the cutting depth to be set. Then, the tiltable body holding the rotary tool is moved toward the cover main body, so that the tiltable body can be coupled to the cover main body via the depth stopper and the coupling unit. Thus, the depth to which the rotary tool cuts into the workpiece can be kept constant during operation of the cutting machine.

In the covering device for the cutting machine described above, however, it is necessary to perform a plurality of operations for adjusting the depth to which the rotary tool cuts into the workpiece. Therefore, when the amount by which the rotary tool projects downward from the base in abutment with the workpiece is changed, an operation for fixing the depth stopper to the tiltable body and an operation for coupling the depth stopper to the coupling unit of the cutter need to be performed. In other words, performing the plurality of operations is required, which makes it complicated when the amount by which the rotary tool projects downward from the base is changed.

### SUMMARY OF THE INVENTION

The present invention has been proposed in view of such circumstances, and therefore has an object to provide a covering device for a cutting machine that facilitates changing the amount by which a rotary tool projects downward from a base, and a cutting machine having the covering device for the cutting machine.

A first aspect of the present invention is a covering device for a cutting machine including a base, a fixing cover which is provided on the base and covers a disc-shaped rotary tool provided at an end of a cutting machine such that the disc-shaped rotary tool is disposed in a vertical orientation and a tiltable body provided in the fixing cover, being coupled to the fixing cover so as to be tiltable in an up-down direction. The cutting machine is mounted to the tiltable body, and an amount by which the rotary tool projects downward from the base can be changed by changes of a tilt position of the tiltable body with respect to the fixing cover. A variable member including a plurality of abutment portions is provided to one of the fixing cover and the tiltable body. The plurality of abutment portions are brought into abutment with the other of the fixing cover and the tiltable body, along with a downward tilt of the tiltable body. The variable member allows the tilt position to be selected from different tilt positions in accordance with an operation to select from the plurality of abutment portions.

A second aspect of the present invention is a covering device for the cutting machine according to the first aspect, in which the variable member is a cam member which is rotationally operable, the plurality of abutment portions are formed in an outer periphery of the cam member, and each abutment portion has different from each other in distance from a center of rotation of the cam member.

A third aspect of the present invention provides a covering device for the cutting machine according to the first aspect, in which the variable member is a step-like member which is slidably operable. The plurality of abutment portions each of which has a different height is formed in the step-like member on a side where the step-like member is brought into abutment with the other of the fixing cover and the tiltable body.

A fourth aspect of the present invention is a covering device for the cutting machine according to the first aspect, in which an arcuate opening portion is formed in the fixing cover to avoid interference between the cutting machine and the fixing cover along with tilting of the tiltable body. Further, a guard member is coupled to a lower portion of the tillable body to block the opening portion below the tiltable body, and an inclined guide portion stands on the base or the fixing cover. The tillable body tilts to a lower-limit tilt position by movement of the guard member away from the opening portion as the tiltable body moves closer to the lower-limit tilt position.

A fifth aspect of the present invention is a covering device for the cutting machine according to the first aspect, in which the variable member is disposed between a metacenter of the tillable body and a center of rotation of the rotary tool.

An sixth aspect of the present invention provides a cutting machine mounted to the tiltable body of the covering device for the cutting machine according to the first aspect, in which the disc-shaped rotary tool provided at an end of the cutting machine is covered by the fixing cover.

According to the covering device for the cutting machine of the first aspect of the present invention and the cutting machine of the sixth aspect of the present invention, the downward tilt position of the tillable body can be changed just by an operation to select from the abutment portions of the variable member. Hence, the amount by which the rotary tool of the cutting machine mounted to the tiltable body projects downward from the base can be changed easily.

According to the covering device for the cutting machine of the second aspect of the present invention, the downward tilt position of the tillable body can be changed just by an operation to rotate the cam member for a selection of a different one of the abutment portions. Consequently, the amount by which the rotary tool projects downward from the base can be changed.

According to the covering device for the cutting machine of the third aspect of the present invention, the downward tilt position of the tiltable body can be changed just by an operation to slide the step-like member for a selection of a different one of the abutment portions. Consequently, the amount by which the rotary tool projects downward from the base can be changed.

According to the cutting machine covering device of the fourth aspect of the present invention, the guard member blocks the arcuate opening portion formed in the fixing cover. This prevents dust from being scattered out of the fixing cover from the opening portion when the rotary tool cuts a workpiece, for example, and also prevents dirt and the like from entering into the fixing cover from the opening portion.

According to the cutting machine covering device of the fifth aspect of the present invention, the covering device for the cutting machine provided with the variable member can be made compact in a space-saving configuration.

### BRIEF DESCRIPTION OF THE DRAWINGS

FIG. 1 is a side view of a cutter according to a first embodiment of the present invention.

FIG. 2 is a perspective view of a covering device for a cutter provided in the cutting device.

FIG. 3 is an exploded perspective view of a tiltable frame, a cam member, and a rotary operation lever which are disposed in the covering device for the cutter.

FIG. 4 shows a state in which a projecting portion of the tiltable frame abuts on an arcuate recessed portion formed in the cam member of the covering device for the cutter.

FIG. 5 is a front view of the covering device for the cutter.

FIG. 6 is a vertical cross-sectional view of the covering device for the cutter.

FIG. 7 is a perspective view of the cutter covering device showing a state in which the tiltable frame is tilted to a lower-limit tilt position.

FIG. 8 shows a state in which a projecting portion of a tiltable frame abuts on a recessed portion formed in a step-like member of a covering device for a cutter provided in a cutter according to a second embodiment.

### DETAILED DESCRIPTION OF THE EMBODIMENTS

### First Embodiment

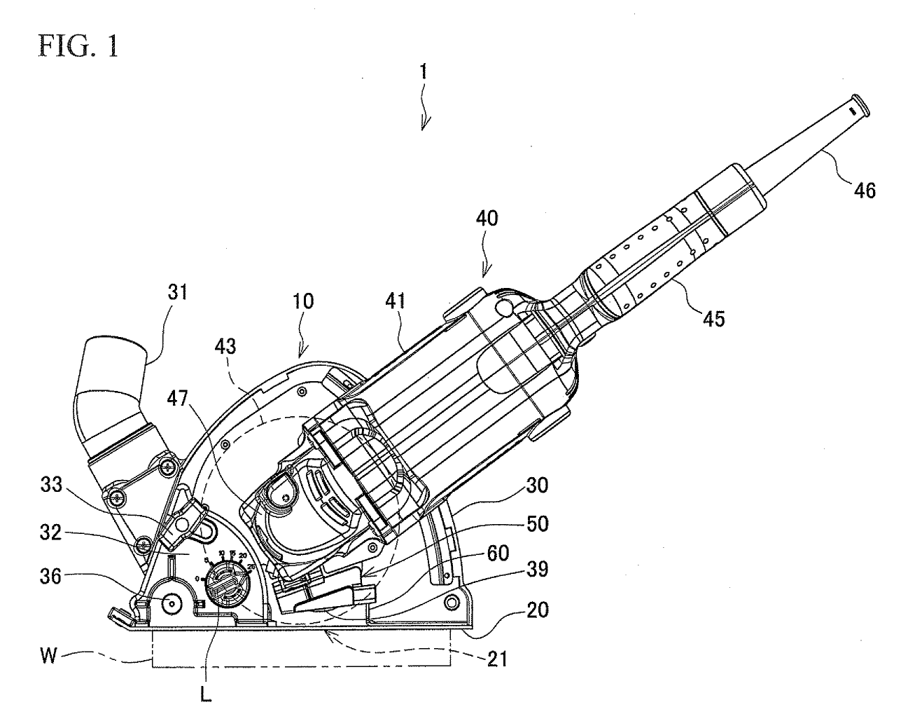

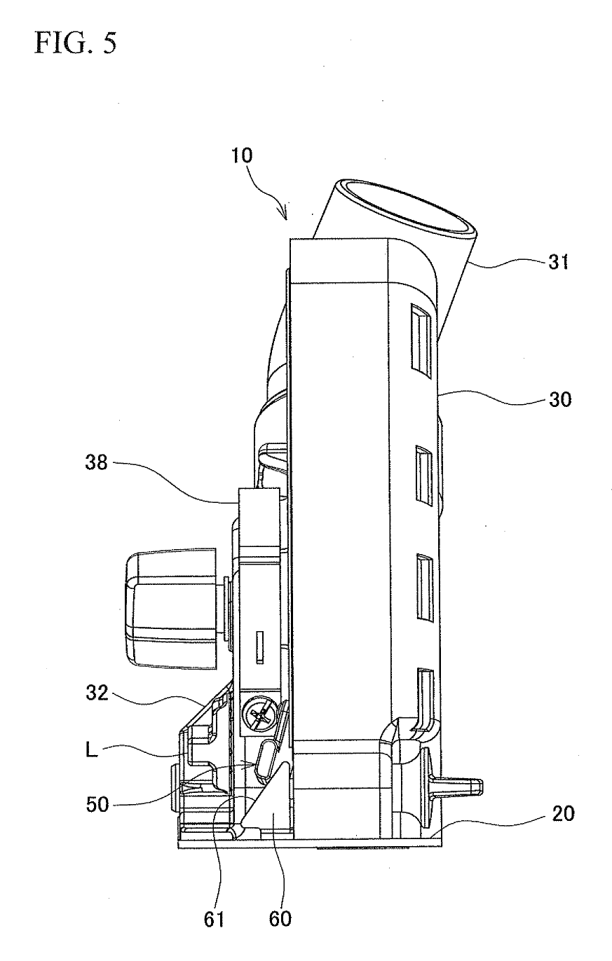

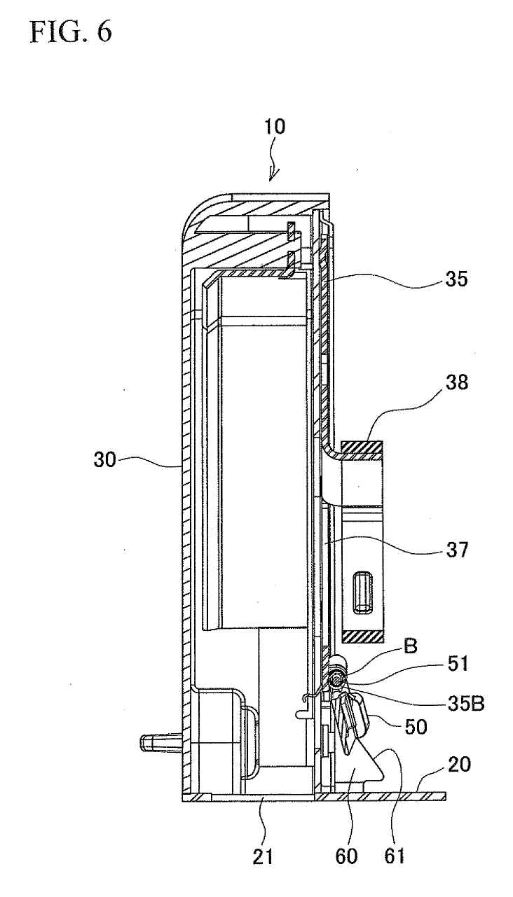

A first embodiment of the present invention will be described with reference to FIGS. 1 to 7. As shown in FIGS. 1 to 4, a cutting device 1 includes a covering device 10 for a cutter 40 and the cutter 40 including a motor housing portion 41 and a grip portion 45. The covering device 10 for the cutter 40 is an example of the covering device for the cutting machine according to the present invention. The cutter 40 is an example of the cutting machine according to the present invention.

The covering device 10 for the cutter 40 includes a base 20 and a fixing cover 30. The base 20 is made of a metal, and formed in a rectangular shape. In use, the base 20 is brought into surface contact with the upper surface of a workpiece W (see FIG. 1) such as a stone material, for example. The base 20 has an opening 21 though which a diamond cutter 43 (see FIG. 1) to be discussed later can be projected downward from the case 20. The fixing cover 30 is made of a synthetic resin, and fixed to the upper surface of the base 20 to stand upright. On the outer surface of the fixing cover 30, a dust collecting tube 31 that communicates with the inside of the fixing cover 30 is provided. A dust collector can be connected to the dust collecting tube 31 via a suction hose.

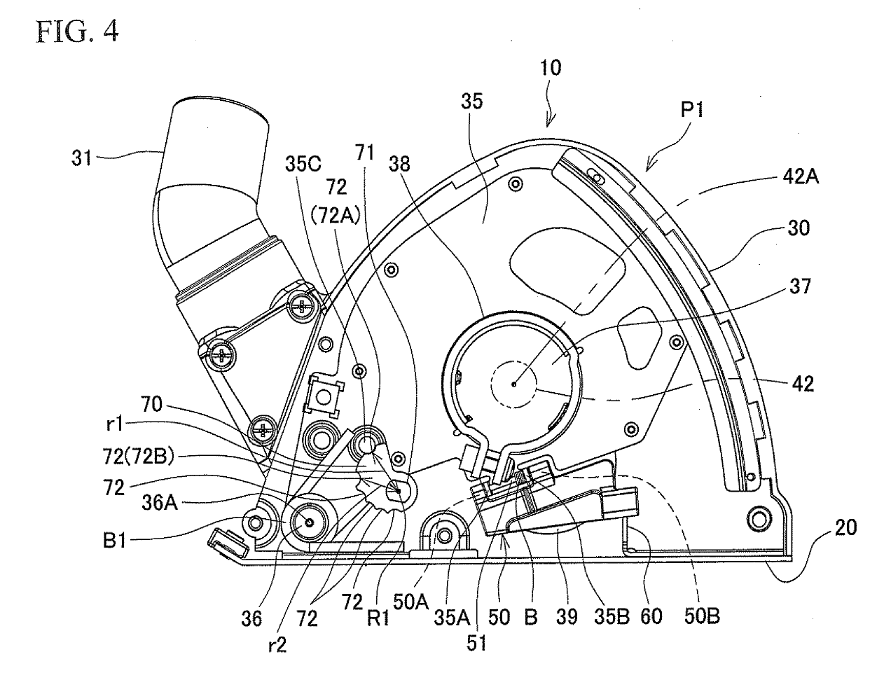

As shown in FIG. 4, a spindle 42 to which rotation of a motor (not shown) is transferred is attached at an end of the motor housing portion 41 and projects into the fixing cover 30. The grip portion 45 is fixed to an upper portion of the motor housing portion 41, being to be used for operation of the cutter 40. A cord 46 is connected to a rear end of the grip portion 45, and electric power for driving the motor is supplied through the cord 46.

As shown in FIGS. 1 to 4, the disc-shaped diamond cutter 43 and a tillable frame 35 are disposed inside the fixing cover 30. The diamond cutter 43 is attached to the spindle 42 so as to be perpendicular to the base 20 and rotates by the motor. As shown in FIG. 1, the fixing cover 30 covers the diamond cutter 43 such that the diamond cutter 43 is disposed in a vertical orientation. The diamond cutter 43 is an example of the disc-shaped rotary tool according to the present invention.

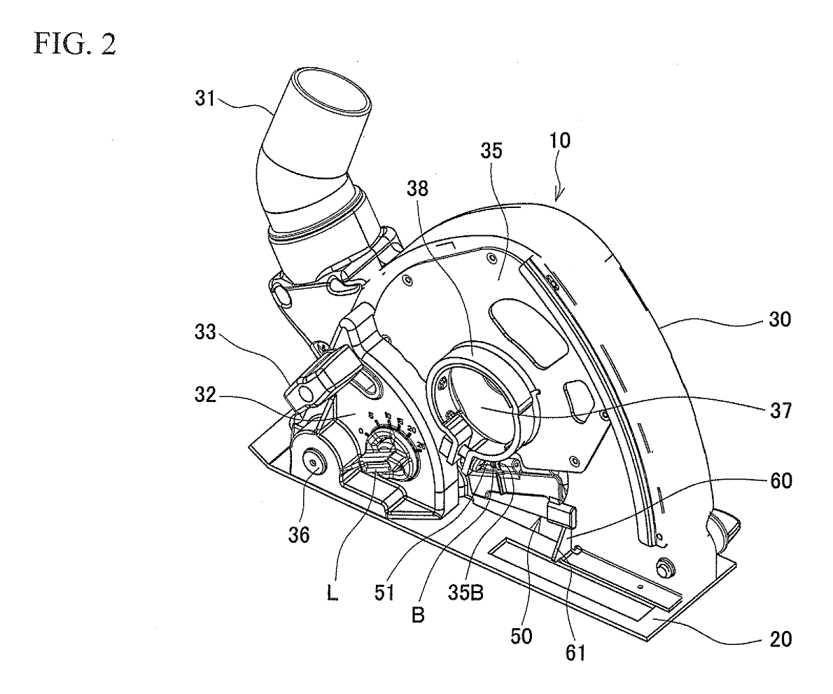

The tillable frame 35 can be tilted in the up-down direction with respect to the base 20 around a tilting support shaft 36 provided in the fixing cover 30. In addition, the tiltable frame 35 is urged by a torsion spring B1 toward an upper-limit tilt position P1 of the tiltable frame 35. As shown in FIGS. 2 to 4, an annular holder portion 38 is provided integrally with the tiltable frame 35 so as to be concentric with a through hole 37 of the tiltable frame 35. A gear case 47 attached to the front portion of the motor housing portion 41 to rotatably support the spindle 42 is fitted with the holder portion 38.

As shown in FIG. 4, an opening portion 39 formed in the shape of an arc curved around the tilting support shaft 36 is provided in a side surface of the fixing cover 30. By tilting the tiltable frame 35, the diamond cutter 43 attached to the spindle 42 projecting from the gear case 47 moves up and down in a rotatable state with respect to the workpiece W set on the lower surface of the base 20. Accordingly, the amount by which the diamond cutter 43 projects downward from the base 20 through the opening 21 of the base 20 (hereinafter referred to as “amount of projection”) can be changed. At this time, the spindle 42 moves up and down with penetrating through the opening portion 39 since interference between the fixing cover 30 and the spindle 42 does not occur. The tiltable frame 35 is an example of the tiltable body according to the present invention.

As shown in FIGS. 2 to 4, a guard member 50 made of a synthetic resin is coupled to the lower portion of the tiltable frame 35 so as to be turnable in the up-down direction of the fixing cover 30. A pair of cut-and-raised portions 35A and 35B are formed in the lower portion of the tiltable frame 35 by cutting and raising of a part of the tiltable frame 35 in the left-right direction in FIG. 4. An insertion hole for a shaft member 51 is provided in each cut-and-raised portion 35A and 35B. A pair of shaft receiving holes 50A and 50B (see FIG. 4) for the shaft member 51 are formed in the upper portion of the guard member 50. The shaft member 51 is inserted into the insertion hole of the cut-and-raised portions 35A and 3513 so that both ends of the shaft member 51 are fitted into the shaft receiving holes 50A and 50B. Then, a coil spring B is fitted with the shaft member 51 so that one end of the coil spring B is retained by the tiltable frame 35. When the tiltable frame 35 is at the upper-limit tilt position P1 as shown in FIG. 4, the guard member 50 is held by the urging force of the coil spring B at a position at which the guard member 50 blocks the opening portion 39 below the tiltable frame 35.

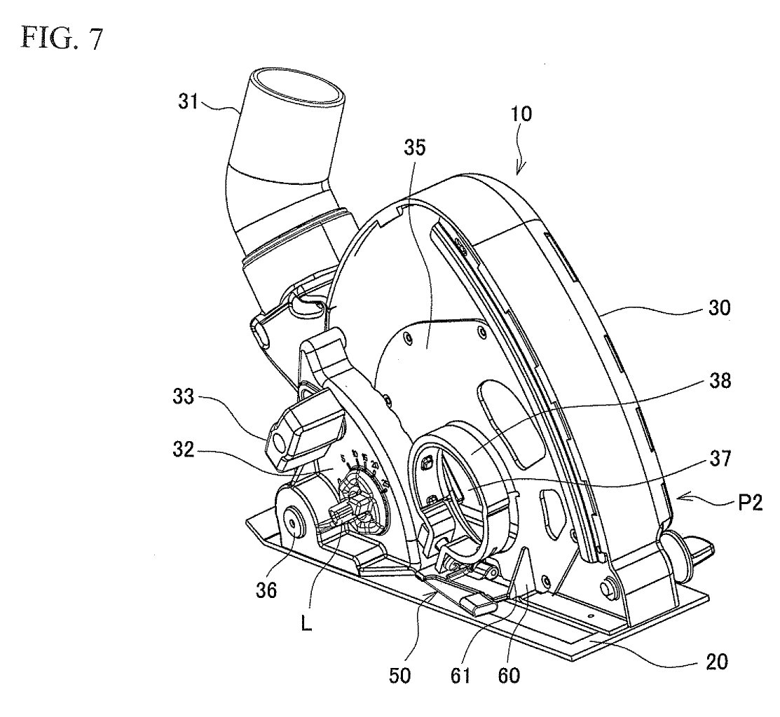

As shown in FIGS. 2, 3, and 5, in addition, an inclined guide portion 60 is provided on the upper surface of the base 20 to stand upright. The inclined guide portion 60 includes an inclined surface 61 facing the guard member 50 and inclining downward toward the front. When the tiltable frame 35 tilts downward so as to be closer to the base 20, the guard member 50 slides downward on the inclined surface 61 while rotating around the shaft member 51 such that the guard member 50 is closer to the base 20. At that time, the guard member 50 moves away from the position at which the guard member 50 blocks the opening portion 39. As a result, the tiltable frame 35 can be tilted to a lower-limit tilt position P2 (see FIG. 7). When the tiltable frame 35 is moved to the lower-limit tilt position P2 as shown in FIG. 7, the surface of the guard member 50 which has been in abutment with the inclined surface 61 is brought into contact with the upper surface of the base 20.

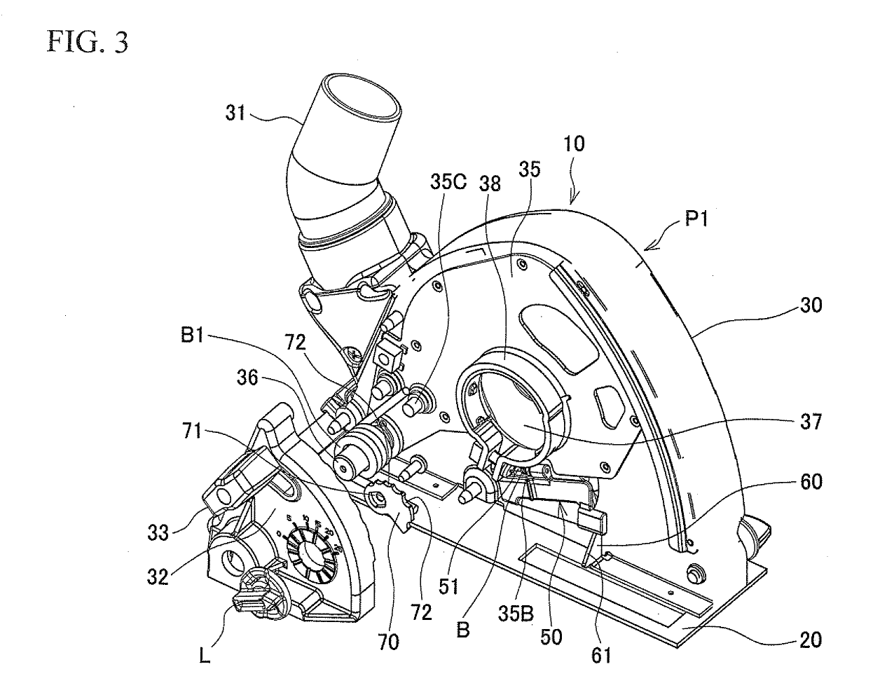

As shown in FIGS. 2 and 3, further, the fixing cover 30 further includes a protective cover 32 made of a synthetic resin. The protective cover 32 is attached to the fixing cover 30 to cover the tilting support shaft 36 and a cam member 70 serving as the variable member from the outer side. A rotary operation lever L is rotatably held by the protective cover 32 with a fixation shaft (not shown) of the rotary operation lever L projecting into the protective cover 32. The cam member 70 is coupled to the fixed shaft of the rotary operation lever L. In the example, the fixation shaft is fitted in a generally rectangular hole portion 71 formed in the cam member 70 to couple the cam member 70 to the fixed shaft, which allows the cam member 70 to rotate together with the rotary operation lever L.

As shown in FIGS. 3 and 4, a plurality of (in the example, six) arcuate recessed portions 72 are formed in the outer peripheral surface of the cam member 70. The plurality of recessed portions 72 are arranged in the circumferential direction and each recessed portion is with a different distance from the center of rotation R1 of the cam member 70. As shown in FIG. 4, the cam member 70 is disposed between the metacenter of the tiltable frame 35 (the metacenter 36A of the tilting support shaft 36) and the center of rotation of the diamond cutter 43 (the center of rotation 42A of the spindle 42).

As shown in FIGS. 3 and 4, in addition, the tiltable frame 35 is provided integrally with a projecting portion 35C. The projecting portion 35C is formed to be brought into abutment with the recessed portions 72 as the tiltable frame 35 is tilted downward closer to the base 20. In the embodiment, an operation to rotate the rotary operation lever L allows one of the recessed portions 72 to be selected as the recessed portion 72 with which the projecting portion 35C is brought into abutment when the tiltable frame 35 is tilted downward. Hence, the tiltable frame 35 can be tilted to one of the different tilt positions corresponding to the selected one of the six recessed portions 72. As a result, the amount of projection of the diamond cutter 43 can be varied in six stages (in the example, 0 mm to 25 mm). In the embodiment, the tiltable frame 35 can be fixed at one of the different tilt positions by a fixation member 33 attached to the tiltable frame 35. The arcuate recessed portions 72 are an example of the abutment portions according to the present invention.

Next, operation of the cutting device 1 according to the embodiment will be described. The operator turns on the cutting device 1, holds the grip portion 45 with his/her hand, and pushes down the grip portion 45 toward the base 20 to move the motor housing portion 41 closer to the base 20. At this time, the tiltable frame 35 is tilted closer to the base 20 around the tilting support shaft 36. FIG. 4 shows a state in which the rotary operation lever L is rotationally operated to select an amount of projection (0 mm) of the diamond cutter 43 so that the projecting portion 35C of the tiltable frame 35 is brought into abutment with a recessed portion 72A corresponding to the selected amount of projection. In this state, even if the operator pushes down the grip portion 45 toward the base 20, the cam member 70 prevents the tiltable frame 35 from downwardly tilting, so that the tiltable frame 35 is held at the upper-limit tilt position P1. Hence, as shown in FIG. 1, the diamond cutter 43 does not project downward from the base 20.

Meanwhile, in the case where the rotary operation lever L is rotationally operated clockwise to select an amount of projection of 5 mm, for example, the cam member 70 coupled to the fixation shaft of the rotary operation lever L is also rotated clockwise. When the operator pushes down the grip portion 45 toward the base 20 thereafter, the tiltable frame 35 can be moved downward from the tilt position P1 by an amount of movement corresponding to the difference (r1−r2) between a distance r1 from the center of rotation R1 of the cam member 70 to the recessed portion 72A and a distance r2 from the center of rotation R1 to another recessed portion 72B. When the projecting portion 35C of the tiltable frame 35 is finally brought into abutment with the recessed portion 72B, the tiltable frame 35 is positioned at a tilt position at which the projecting portion 35C and the recessed portion 72B are in abutment with each other. Thus, the amount of projection of the diamond cutter 43 can be kept at 5 mm, which allows the diamond cutter 43 to cut into the workpiece W. Dust produced when the workpiece W is cut is collected by the dust collector from the dust collecting tube 31 via the suction hose. At this time, the guard member 50 blocks the opening portion 39 of the fixing cover 30 to block communication between the inside and the outside of the fixing cover 30. Hence, it is possible to prevent the dust from being scattered out of the fixing cover 30, and to also prevent dirt and the like from entering into the fixing cover 30 from the opening portion 39.

In the above example, amounts of projection of the diamond cutter 43 of 0 mm and 5 mm are selected as shown in FIG. 4, however, the rotary operation lever L may be rotationally operated to select amounts of projection of 10 mm to 25 mm. Further, the tiltable frame 35 may be positioned at a tilt position at which the projecting portion 35C is in abutment with the recessed portion 72 corresponding to the selected amount of projection. This allows the diamond cutter 43 to be projected by the selected amount of projection.

### Effects of First Embodiment

In the covering device 10 for the cutter 40 according to the embodiment and the cutting device 1 including the covering device 10 for the cutter 40, the position to which the tiltable frame 35 tilts downward can be changed just by selecting a different one of the arcuate recessed portions 72 by rotationally operating the cam member 70 together with the rotary operation lever L. Consequently, the amount of projection of the diamond cutter 43 mounted to the tiltable frame 35 can be changed easily.

In addition, as the guard member 50 blocks the opening portion 39 formed in a side surface of the fixing cover 30, dust is prevented from being scattered out of the fixing cover 30 from the opening portion 39 when the diamond cutter 43 cuts the workpiece W. Further, dirt and the like is prevented from entering into the fixing cover 30 from the opening portion 39.

Further, the cam member 70 is disposed between the metacenter of the tillable frame 35 and the center of rotation of the diamond cutter 43. Therefore, the covering device 10 for the cutter 40 provided with the cam member 70 can be made compact in a space-saving configuration.

### Second Embodiment

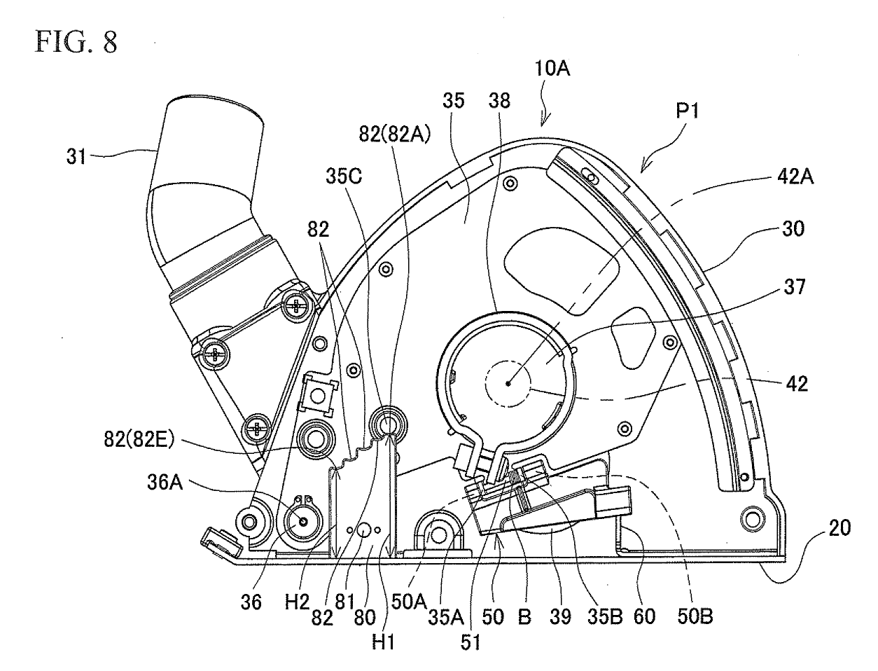

A second embodiment of the present invention will be described with reference to FIG. 8. The same components as those according to the first embodiment are denoted by the same reference numerals, and are not described here. A covering device 10A for a cutter shown in FIG. 8 includes a step-like member 80, covered by a protective cover (not shown) such as that according to the first embodiment. A bar-shaped slide operation lever 81 is provided to project from the front surface of the step-like member 80. A long hole that is elongated in the front-back direction of the protective cover (the left-right direction of FIG. 8) is formed in the protective cover. The slide operation lever 81 is disposed to project out of the protective cover from the long hole. An operation to slide the slide operation lever 81 in the front-back direction enables the step-like member 80 to slide in the front-back direction on the base 20.

A plurality of (in the example, five) recessed portions 82 are formed in the upper end surface of the step-like member 80. Each recessed portion 82 has a different height from the lower end surface of the step-like member 80 so as to form a step-like configuration. As with the cam member 70 according to the first embodiment, the step-like member 80 is disposed between the metacenter of the tiltable frame 35 and the center of rotation of the diamond cutter 43.

In the embodiment, an operation to slide the slide operation lever 81 allows one of the recessed portions 82 to be selected as the recessed portion 82 with which the projecting portion 35C is brought into abutment when the tiltable frame 35 is tilted downward. Hence, the tiltable frame 35 can be tilted to one of different tilt positions as in the first embodiment. The amount of projection of the diamond cutter 43 can be varied in five stages (in the example, 0 mm to 20 mm). The recessed portions 82 are an example of the abutment portions according to the present invention.

Next, operation of a cutter including the covering device 10A for the cutter according to the embodiment will be described. FIG. 8 shows a state in which the slide operation lever 81 is slidably operated to select an amount of projection (0 mm) of the diamond cutter 43 so that the projecting portion 35C is brought into abutment with a recessed portion 82A corresponding to the selected amount of projection. In this state, as in the first embodiment, the tiltable frame 35 is held at the upper-limit tilt position P1 and the diamond cutter 43 does not project downward from the base 20.

Meanwhile, in order to select an amount of projection of 20 mm, for example, the slide operation lever 81 is slidably operated toward the rear of the fixing cover 30 (toward the right of FIG. 8) to slide the step-like member 80 rearward. When the operator pushes down the grip portion 45 toward the base 20, and then tiltable frame 35 can be moved downward from the tilt position P1 by an amount of movement corresponding to the difference (H1−H2) between a height H1 from the lower end surface of the step-like member 80 to the recessed portion 82A and a height H2 from the lower end surface to another recessed portion 82E. When the projecting portion 35C is finally brought into abutment with the recessed portion 82E, the tiltable frame 35 is positioned at a tilt position at which the projecting portion 35C and the recessed portion 82E are in abutment with each other. Thus, the amount of projection of the diamond cutter 43 can be kept at 20 mm, which allows the diamond cutter 43 to cut into the workpiece W.

In FIG. 8, amounts of projection of the diamond cutter 43 of 0 mm and 20 mm are selected. However, the slide operation lever 81 may be slidably operated to select amounts of projection of 10 mm etc. Further, in this case, the tiltable frame 35 may be positioned at a tilt position at which the projecting portion 35C is in abutment with the recessed portion 82 corresponding to the selected amount of projection. This allows the diamond cutter 43 to be projected by the selected amount of projection.

### Effects of Second Embodiment

In the covering device 10A for the cutter according to the embodiment and the cutter including the covering device 10A for the cutter, the position to which the tiltable frame 35 tilts downward can be changed just by selecting a different one of the recessed portions 82 by slidably operating the step-like member 80 using the slide operation lever 81. Consequently, the amount of projection of the diamond cutter 43 mounted to the tiltable frame 35 can be changed.

The present invention is not limited to the embodiments discussed above, and part of the configuration of the embodiments may be modified appropriately without departing from the gist of the present invention. For example, unlike the first embodiment discussed above, a cam member may be held by the tiltable frame 35 so as to be rotationally operable, a projecting portion that can be brought into abutment with a recessed portion of the cam member may be provided to the protective cover 32 provided to the fixing cover 30, and the tiltable frame 35 may be positioned at a tilt position at which the recessed portion and the projecting portion are in abutment with each other.

In addition, unlike the first and second embodiments discussed above, the inclined guide portion 60 may be fixed to the fixing cover 30, and the guard member 50 may be moved downward with respect to the fixing cover 30 while sliding on the inclined surface 61 of the inclined guide portion 60. Further, unlike the first embodiment discussed above, five or less or seven or more recessed portions 72 may be formed in the outer peripheral surface of the cam member to vary the amount of projection of the diamond cutter 43 in a multiplicity of stages. Moreover, unlike the second embodiment discussed above, four or less or six or more recessed portions 82 may be formed in the upper end surface of the step-like member so as to form a step-like configuration to vary the amount of projection of the diamond cutter 43 in a multiplicity of stages.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A covering device for a cutting machine comprising:
a base;
a fixing cover which is provided on the base and covers a disc-shaped rotary tool provided at an end of a cutting machine such that the disc-shaped rotary tool is disposed in a vertical orientation; and
a tiltable body provided in the fixing cover and being coupled to the fixing cover so as to be tiltable in an up-down direction, the cutting machine being mounted to the tiltable body, wherein
an amount by which the rotary tool projects downward from the base can be changed by a change of a tilt position of the tiltable body with respect to the fixing cover; and
a variable member is provided to one of the fixing cover and the tiltable body, the variable member including a plurality of abutment portions that are brought into abutment with the other of the fixing cover and the tiltable body along with a downward tilt of the tiltable body, and the variable member allowing the tilt position to be selected from different tilt positions in accordance with an operation to select from the plurality of abutment portions.

2. The covering device for the cutting machine according to claim 1, wherein
the variable member is a cam member which is rotationally operable, the plurality of abutment portions are formed in an outer periphery of the cam member, and each abutment portion is set at a different distance from a center of rotation of the cam member.

3. The covering device for the cutting machine according to claim 1, wherein
the variable member is a step-like member which is slidably operable, the plurality of abutment portions are formed in the step-like member on a side where the step-like member is brought into abutment with the other of the fixing cover and the tiltable body, and each abutment portion has a different height.

4. The covering device for the cutting machine according to claim 1, wherein
an arcuate opening portion is formed in the fixing cover to avoid interference between the cutting machine and the fixing cover along with the tilt of the tiltable body, a guard member is coupled to a lower portion of the tiltable body to block the opening portion below the tiltable body, and an inclined guide portion stands on the base or the fixing cover to allow the tillable body to be tilted to a lower-limit tilt position by moving the guard member away from the opening portion as the tillable body moves closer to the lower-limit tilt position.

5. The covering device for the cutting machine according to claim 1, wherein
the variable member is disposed between a metacenter of the tiltable body and a center of rotation of the rotary tool.

6. The covering device for the cutting machine according to claim 2, wherein
the cam member is provided to the fixing cover, and the abutment portions are formed as arcuate recessed portions; and
the tillable body includes a projecting portion that is brought into abutment with the recessed portion along with the downward tilt of the tiltable body.

7. The covering device for a cutting machine according to claim 3, wherein
the step-like member is provided to the fixing cover, the side where the step-like member is brought into abutment with the tiltable body is an upper end surface of the step-like member, the abutment portions are formed as a plurality of recessed portions, and each abutment portion has a different height from a lower end surface of the step-like member; and
the tiltable body further includes a projecting portion that is brought into abutment with the recessed portion along with the downward tilt of the tiltable body.

8. The covering device for the cutting machine according to claim 7, wherein
the step-like member has a slide operation lever provided to the step-like member to project out of the fixing cover so as to be slidably operable.

9. The covering device for the cutting machine according to claim 4, wherein
a tilting support shaft is provided with the fixing cover and supports the tiltable body such that the tiltable body is tiltable in the up-down direction, and the arcuate opening portion is formed in the fixing cover to be centered on the tilting support shaft;
a spindle of the cutting machine to which the rotary tool is attached is supported rotatably by the tiltable body; and
the spindle can move up and down with being penetrated through the opening portion as the tiltable body is tilted.

10. The covering device for the cutting machine according to claim 4, wherein
the guard member is coupled to a lower portion of the tiltable body so as to be turnable in the up-down direction, the inclined guide portion stands on the base, and the inclined guide portion includes an inclined surface inclined forward and downward and facing the guard member; and
the guard member slides on the inclined surface to turn away from the opening portion along with the downward tilt of the tiltable body.

11. A cutting machine mounted to the tiltable body of the covering device for the cutting machine according to claim 1, wherein
the disc-shaped rotary tool provided at an end of the cutting machine is covered by the fixing cover.
